(19) United States
(12) Patent Application Publication
(10) Pub. No.: US 2025/0083481 A1
(43) Pub. Date: Mar. 13, 2025

(54) TOWABLE UTILITY VEHICLE

(71) Applicant: John Temp Cannon, Longview, TX (US)

(72) Inventor: John Temp Cannon, Longview (TX)

(21) Appl. No.: 18/883,852

(22) Filed: Sep. 12, 2024

Related U.S. Application Data
(60) Provisional application No. 63/629,028, filed on Sep. 13, 2023.

(51) Int. Cl. B60D 1/46; B62D 9/00; B62D 61/06

(52) U.S. Cl. CPC B60D 1/46; B62D 9/00; B62D 61/065

(57) ABSTRACT

A towable off-road vehicle with a towing engagement system for elevating the vehicle whereby, when engaged for towing with a towing vehicle, only certain wheels that are reversibly lockable for steering are engaged with a road surface over which the off-road vehicle is the be moved.

### CROSS-REFERENCE TO RELATED APPLICATION

This application is based on and claims the benefit of U.S. Provisional Application No. 63/629,028 filed Sep. 13, 2023, the disclosure of which is incorporated by reference herein in its entirety.

### BACKGROUND

### 1. Field

The present invention relates to off-road utility or all-terrain vehicles (ATVs).

### 2. Description of Related Art

Off-road utility vehicles and conventionally identified “All-Terrain Vehicles” (ATVs) are popular for many purposes. These vehicles (which will be referenced collectively as “ATVs” hereafter, are used recreationally such as for trail riding, exploring rugged terrain, camping, and hunting. Many ATV users enjoy off-roading in forests, deserts, and mountain areas, often on trails specifically designed for ATVs. The ATV provide an adventurous way to explore natural settings that are difficult to access with other vehicles.

ATVs are also used extensively in agriculture, ranching, and other outdoor industries. Farmers and ranchers use them to transport equipment, feed livestock, check fences, and perform various tasks over large areas. They are also used by park rangers, wildlife officers, and search and rescue teams for accessing remote or challenging terrains.

Some ATV variants are even used in competitive contexts, such as motocross, cross-country, and endurance racing. Further still, some military and law enforcement agencies use ATVs for operations in rough terrain where traditional vehicles are not suitable. They are valuable for patrolling borders, conducting search and rescue missions, and quickly accessing hard-to-reach locations.

A still further variant of an off-road vehicle, and broadly speaking an “ATV” would be a golf cart. References to any “ATV” or “off-road vehicle” hereafter should be understood to include the possibility of implementation as a golf cart.

The global ATV market has been growing steadily. This is not only due to the inherent attractiveness of this vehicle for the reasons stated, but also because ATV design and sophistication has evolved over the years in a number of positive ways, thus broadening the appeal to ever larger prospective users. Improvements include features such as electronic power steering, automatic transmissions, and enhanced suspension systems.

One design variant in the ATV realm is that of the three-wheel ATV (with two wheels in the front and one in the back), commonly referred to as a “reverse trike” configuration. The three-wheel ATV offers several unique advantages, particularly in terms of stability, handling, and safety.

With two wheels in the front (often spaced farther apart than the wheels are in a typical four-wheel variant, and obviously presenting a wider stance that a single front wheel, forward trike variant), the reverse trike configuration provides a wider forward stance, which enhances stability during turns and on uneven terrain. The wider front-end reduces the likelihood of tipping over, especially in sharp turns or when navigating slopes. This stability makes it a safer option for both experienced and novice riders.

The reverse trike design also allows for more even weight distribution between the front and back of the ATV, versus that of a forward trike variant. The two front wheels carry more of the ATV's weight, which helps improve traction and stability. This weight distribution also reduces the risk of the ATV flipping backward when accelerating uphill or over obstacles.

With two wheels in the front, the ATV can utilize dual front brakes, providing more effective braking power than a single front-wheel setup. This configuration allows for better control during sudden stops or when navigating down steep slopes, reducing the risk of skidding or loss of control.

Whatever the variant of an ATV one might use, at least one major impediment to use and enjoyment remains: the costs, inconveniences and even challenges involved in getting one's ATV from one place to another. ATVs are not street-legal in most areas. Therefore, to transport an ATV over public streets and roads, from one off-roading site to another, owners typically need a suitable tow vehicle (such as a truck or SUV) as well as a trailer of some kind. Trailers specifically designed for ATVs can cost anywhere from a few hundred to several thousand dollars, depending on their size and quality. Furthermore, trailers require separate registration and license tag fees. Additional accessories, such as tie-down straps, ramps, and protective covers, are also necessary to secure the ATV during transport and add additional expense to the trailer transport of an ATV.

When using a trailer for ATV relocation, loading and unloading the ATV requires effort and can be time-consuming and even dangerous, especially if done alone.

The combined additional weight on an ATV and its trailer can also significantly increase fuel consumption for the tow vehicle, adding to transportation costs, and for a towing vehicle that is not particularly robust, can even shorten the life of the towing vehicle itself (especially its transmission).

The equipment and increased operating expense involved in relocating an ATV through use of a trailer is only the beginning of negatives in such ATV transport. Transporting an ATV with a trailer can make parking and maneuvering more difficult, especially in crowded areas or narrow roads. The owner must be comfortable with maneuvering a vehicle/trailer assemblage, especially if rearward movement is required.

Once arriving at a location by way of trailer-borne ATV transport, not only the towing vehicle, but the trailer remains to be parked. While vehicle theft is always a possibility, trailers are far more easily stolen than most motor vehicles. So, there is either the cost of a secure parking location (often not available at desired destinations for ATV use) or the risk of trailer theft, the latter visiting considerable cost and inconvenience for the ATV user (the latter involving that of being “stranded” at any away-from-home, remote site that was visited for ATV use.

### SUMMARY

In view of the foregoing, it would be advantageous to provide a design for a towable ATV (one not requiring a trailer of any kind) and particularly one of the reverse trike design.

The present applicable here provides the requisite disclosure for an improved design for a towable ATV, including that for a three-wheel, or reverse trike ATV variant. The preferred embodiment exemplified here is easily and quickly convertible between a use configuration and a towing configuration. The present design wholly obviates the need and associated costs, inconveniences and even hazards associated with use of a trailer to transport an ATV over public streets and roads.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an elevational view of one embodiment of a towable ATV of the present disclosure;

FIG. 2 depicts a portion of the ATV's steering assemblage and steering locking pin for configuring the ATV for being towed; and

FIG. 3 is a depiction of a present embodiment of the ATV of FIG. 1, with its elevating towing tongue deployed and interfaced with the ATV's towing tongue receiver and positioned for engagement with a hitch ball of a towing vehicle.

### DETAILED DESCRIPTION

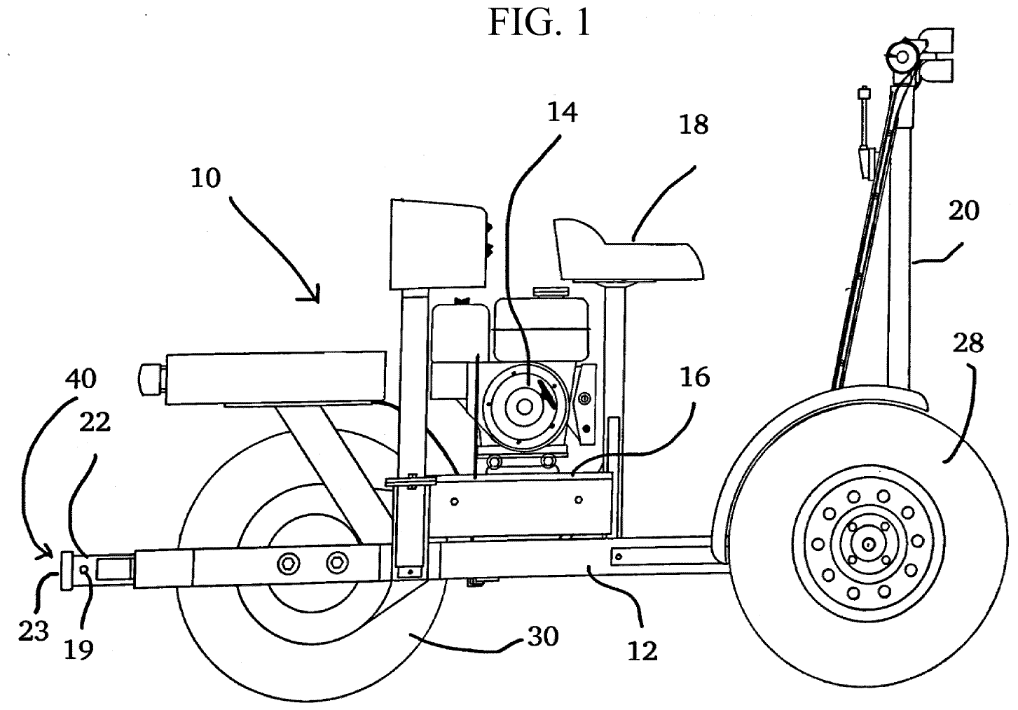

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Referring particular to FIG. 1, the ATV 10 of the present design is a three-wheel or “reverse trike” ATV design variant. A frame 12 of ATV 10 (whether of a unibody or multiple-component frame assembly design) supports, at least in the preferred embodiment, an engine or motor 14, a transmission (or other power transmitting assemblage or system for transmitting rotational force to the powered wheel(s)) 16, rider seat(s) 18, steering assembly 20, towing tongue receiver 22 and axle assemblages 24 and 26, respectively, for the forward wheels 28 and rear wheel 30.

In the preferred embodiment, the rear wheel 30 is, in the present embodiment, the sole powered wheel, while the front two wheels 28 are free-wheeling and steerable by a steering assembly 20. The rotational forces for driving the powered rear wheel 30 in the depicted design is produced by engine 14 and transmitted to the rear wheel 30 by way of a power train that includes transmission 16.

Alternative embodiments could be EV versions with, for example, a direct wheel drive electric motor for each powered wheel with an on-board power cell. Also, variations of the present design could include, especially in the case of an EV variant, powered front wheels. In that case, however, there must be a setting that allows for these wheels being set to a free-wheeling mode during a towing operation.

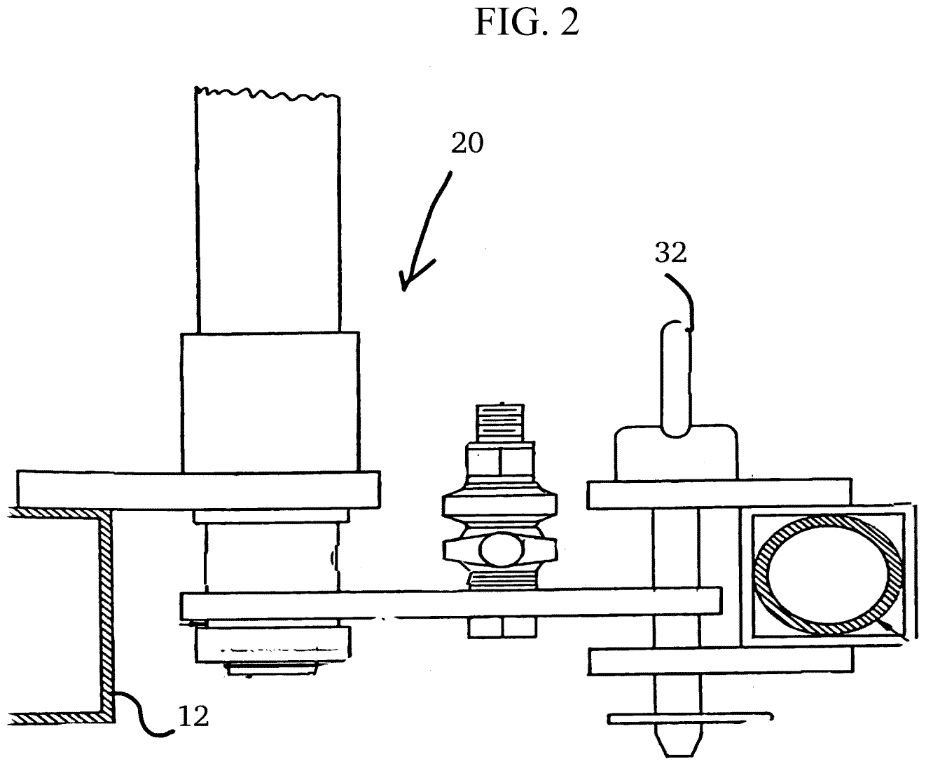

Steering assembly 20 may be of any number of conventional designs, from a manual, riding lawn mower type assembly, to a rack and pinion design, to even a power-assisted steering unit. Referring particularly to FIG. 2, the steering assembly 20 of whichever design is chosen include a steering lock 32. Steering lock 32 is engaged to secure front wheels 28 (or any ground-engaging wheels when ATV 10 is in its towing configuration) in a fixed orientation (preferably parallel with the long axis of the vehicle). Steering lock 32 can be a pin of some nature that extends through two or more ATV 10 components, at least one of which is a component of the steering assembly 20 to reversibly secure the assembly 20 in a non-steering configuration (the wheels used to steer the ATV 10 are fixed, preferably in an orientation whereby when the ATV 10 is towed, it tracks in parallel to the long axis of the ATV 10). Another option (not shown in the drawings) may involve a reversibly sliding pin or tab that is slidably mounted to one component of the ATV 10 and when pushed from a first disengaged position to an engaged position interfaces with at least one moveable component of the steering assembly 20 to render it substantially unmovable to thereby “lock” the steering assembly. A still further option for locking the steering assembly 20 for towing (not shown in the drawings) may be a frictional locking mechanism that, when actuated, prevents annular rotation of any steering column of steering assembly 20, again, to secure the steerable, ground-engaging wheels in a fixed orientation for a towing operation.

An important feature of the present design-one that makes it practical for the ATV to be easily convertible between riding and towing configurations-relates to the interface between the ATV 10 and any vehicle 50 by which it is to be towed). During use of the ATV 10, any such interface must not interfere with normal operation, and not project from the vehicle in such a way and degree as to create a safety hazard. Therefore, the present design involves a removable such interface (to be discussed below).

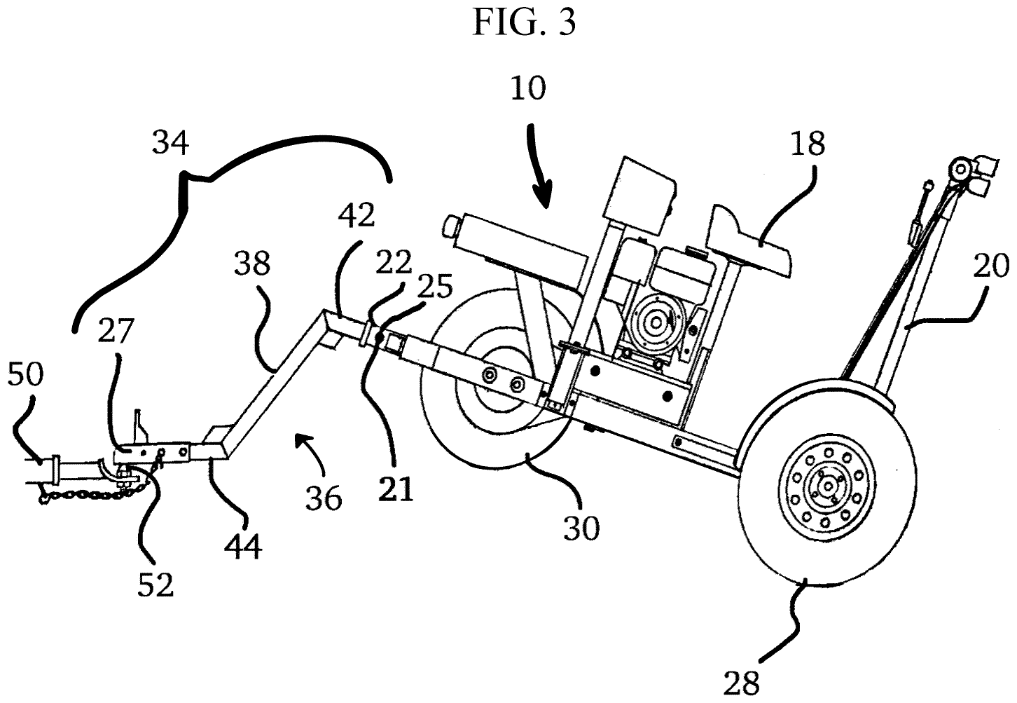

Referring particularly to FIG. 3, in the depicted embodiment, an ATV/vehicle interface is provided in the form of an adaptable towing tongue assembly 34. Adaptable towing tongue assembly 34 includes an elevating towing tongue 36 and the previously mentioned towing tongue receiver 22.

Elevating towing tongue 36 is configured such that when it is deployed (attached to the ATV 10 at the and engaged with ATV 10 via the towing tongue receiver 22), as well as being attached to the towing vehicle 50 for towing, the rearward end 40 of the ATV 10 is lifted sufficiently but not excessively separate the powered wheel 30 from the road surface over which the ATV 10 is to be towed.

The configuration of the elevating towing tongue 36 (the above-referenced “interface”) will in the preferred embodiment involve an elevational segment 38 extending between its proximal ATV engagement portion 42 and its distal towing vehicle engagement portion 44. Elevational segment 38 of elevating towing tongue 36 is angularly attached to ATV engagement portion 42 and towing vehicle engagement portion 44 to both provide spatial distance between the towing vehicle 50 and the ATV 10, but also to affect a differential elevation (relative to an underlying road surface) between its proximal ATV engagement portion 42 and the attachment point of the towing vehicle engagement portion 44 to the towing vehicle 50.

This is all to be configured such the rear end 40 of the ATV 10 will be sufficiently, but not excessively lifted for safe transport Adjustments to the length of elevational segment 38 and of its angular intersection with ATV engagement portion 42 and the towing vehicle engagement portion 44, all in view of the desired lift for the ATV 10′s rearward end 40 during towing and of the height above a road surface of the anticipated towing vehicle 50′s hitching structure is well within the skill set of at least any trailer or vehicle towing accessory related designer or installer. Given the somewhat standardized hitch height of groups of stock automobiles and trucks, stocks of several standardized elevating towing tongue 36 may be stocked by suppliers, while customized ones may be fabricated for such as “lifted” trucks with highly elevated hitch heights, for examples.

In most cases the desired lift, or “rise” from the ATV engagement portion 42 to the towing vehicle engagement portion 44 to achieve the desired lift of the ATV 10 is achieved by way of the respective, relative angular intersection of the elevational segment 38 (of an overall length between about 2 feet and 4 feet, whether or one or multiple constituent lengths) with each of the ATV engagement portion 42 and its distal vehicle engagement portion 44 that produces respective interior and exterior angles formed by such intersection of the axis of the elevational segment 38 with the axes of the ATV engagement portion 42 of between approximately 20° and 50° and between 130° and 160° respectively.

That which would be “excessive lifting”, and the therefore dictating the appropriate overall configuration of the elevating towing tongue 36 can be determined by any person of ordinary skill in the art of towable vehicles and trailer design, when considering the likely elevation above a road surface of, for example, the hitch ball or hitch receiver for the intended towing vehicle. Generally, however “excessive lifting” in this case would be lifting the rear end 40 of the ATV 10 to a degree that would so orient its long axis toward the vertical (relative to the horizon) as to make rearward movement of the linked towing vehicle and ATV 10 nearly impossible without “jackknifing”. Certainly anything approaching a 45 degrees from the horizontal (and likely anything more than about 30 degrees) would pose such a risk and would be considered “excessive”.

Referring to FIGS. 1 and 3, in the preferred embodiment, the towing tongue receiver 22 of the towing tongue assembly 34 facilitates easy transition from deployed to undeployed configurations. Referring again principally to FIG. 1, the towing tongue receiver 22 of the preferred embodiment provides a square orifice 23 such as is often found in the hitch receiver portion of the linkage between vehicles and trailers and is for telescopically receiving the ATV engagement portion 42 of the elevating towing tongue 36. The towing tongue receiver 22 is configured for conventional securing means (such as by having compatibly sized and positioned holes 19 for alignment with holes 21 in the elevating towing tongue 36 for reversibly receiving a securing pin 25, much as is commonly the security means by which conventional trailer hitches and hitch receivers are reversibly secured.

Referring principally to FIG. 3, the towing vehicle engagement portion 44 of elevating towing tongue 36 is, in one preferred embodiment, fitted with a suitable hitch assembly 27 for linkage with a vehicle 50 with an existing hitch ball 52 of a towing vehicle. Alternatively (not shown in the drawings), the towing vehicle engagement portion 44 of elevating towing tongue 36 can be configured substantially the same manner as described for the ATV engagement portion 42 (for use with vehicles having conventional receivers from which any hitch can be removed and the towing vehicle engagement portion 44 of elevating towing tongue 36 can be engaged instead).

It is important to note that merely configuring an ATV to be capable of being towed does not necessarily make it legally so. The preferred embodiment of the present ATV design includes U.S. Department of Transportation-approved tires, hubs, axles, and bearings, just as any “street-legal” trailer would include.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

Although the present disclosure has been described with various embodiments, various changes and modifications may be suggested to one skilled in the art. It is intended that the present disclosure encompass such changes and modifications as fall within the scope of the appended claims.

What is claimed is:

1. A towable off-road vehicle comprising:
an off-road vehicle frame;
a plurality of wheels rotatable interfaced with said off-road vehicle frame;
a propulsion power source interfaced with said off-road vehicle frame and configured for imparting force to one or more of said wheels for effecting movement of said off-road vehicle frame over a surface;
a steering assembly interfaced with said off-road vehicle frame and with one or more of said wheels for steering said frame by manipulation of a user of said vehicle;
a tongue attachment structure attached to said off-road vehicle frame; and
an elevating towing tongue having:
an off-road vehicle frame engagement portion extending from a first tongue terminus and configured for reversible attachment to said tongue attachment structure of said off-road vehicle frame;
an elongate elevational segment attached at a first elevational segment end to said vehicle frame engagement portion; and
a towing vehicle portion extending from a second elevational segment end and configured for reversible attachment to a towing vehicle; whereby
when said elevating towing tongue is deployed in a towing configuration by attachment to said tongue attachment structure, said towing vehicle portion is at a greater first distance from a surface on which said off-road vehicle rests than a lesser second distance over which said off-road vehicle frame engagement portion is separated from said surface.

2. The vehicle of claim 1 wherein said an off-road vehicle frame engagement portion of said elevating towing tongue is attached to and oriented relative to said elongate elevational segment whereby said second axis intersects said first axis with an interior angle of between approximately 20° and 50°, and said towing vehicle portion is attached to and oriented relative to said elongate elevational segment whereby said second axis intersects said third axis with an exterior angle of between approximately 130° and 160°.

3. The vehicle of claim 1 further comprising steering locking means for reversibly securing said steering assembly in a fixed configuration for maintaining said one or more of said wheels for steering said frame by manipulation of a user of said vehicle in a fixed orientation.

4. The vehicle of claim 2 further comprising steering locking means for reversibly securing said steering assembly in a fixed configuration for maintaining said one or more of said wheels for steering said frame by manipulation of a user of said vehicle in a fixed orientation.

5. The vehicle of claim 1 wherein said plurality of wheels comprises are arranged whereby:
first and second wheels are respectively, rotatably and pivotally engaged to said off-road vehicle frame adjacent to a front end of said off-road vehicle frame and are operably interfaced with said steering assembly; and
a third wheel is rotatably engaged to said off-road vehicle frame adjacent to a rear end of said off-road vehicle frame.

6. The vehicle of claim 2 wherein said plurality of wheels comprises are arranged whereby:
first and second wheels are respectively, rotatably and pivotally engaged to said off-road vehicle frame adjacent to a front end of said off-road vehicle frame and are operably interfaced with said steering assembly; and
a third wheel is rotatably engaged to said off-road vehicle frame adjacent to a rear end of said off-road vehicle frame.

7. The vehicle of claim 3 wherein said plurality of wheels comprises are arranged whereby:
first and second wheels are respectively, rotatably and pivotally engaged to said off-road vehicle frame adjacent to a front end of said off-road vehicle frame and are operably interfaced with said steering assembly; and
a third wheel is rotatably engaged to said off-road vehicle frame adjacent to a rear end of said off-road vehicle frame.

8. The vehicle of claim 4 wherein said plurality of wheels comprises are arranged whereby:
first and second wheels are respectively, rotatably and pivotally engaged to said off-road vehicle frame adjacent to a front end of said off-road vehicle frame and are operably interfaced with said steering assembly; and
a third wheel is rotatably engaged to said off-road vehicle frame adjacent to a rear end of said off-road vehicle frame.

9. The vehicle of claim 1 wherein said plurality of wheels comprises are arranged whereby:
first and second wheels are respectively, rotatably engaged to said off-road vehicle frame adjacent to a front end of said off-road vehicle frame; and
a third wheel is rotatably and pivotally engaged to said off-road vehicle frame adjacent to a rear end of said off-road vehicle frame and operably interfaced with said steering assembly.

10. The vehicle of claim 2 wherein said plurality of wheels comprises are arranged whereby:
first and second wheels are respectively, rotatably engaged to said off-road vehicle frame adjacent to a front end of said off-road vehicle frame; and
a third wheel is rotatably and pivotally engaged to said off-road vehicle frame adjacent to a rear end of said off-road vehicle frame and operably interfaced with said steering assembly.

11. The vehicle of claim 3 wherein said plurality of wheels comprises are arranged whereby:
first and second wheels are respectively, rotatably engaged to said off-road vehicle frame adjacent to a front end of said off-road vehicle frame; and
a third wheel is rotatably and pivotally engaged to said off-road vehicle frame adjacent to a rear end of said off-road vehicle frame and operably interfaced with said steering assembly.

12. The vehicle of claim 4 wherein said plurality of wheels comprises are arranged whereby:
first and second wheels are respectively, rotatably engaged to said off-road vehicle frame adjacent to a front end of said off-road vehicle frame; and
a third wheel is rotatably and pivotally engaged to said off-road vehicle frame adjacent to a rear end of said off-road vehicle frame and operably interfaced with said steering assembly.
